(19) United States
(12) Patent Application Publication
(10) Pub. No.: US 2020/0186553 A1
(43) Pub. Date: Jun. 11, 2020

(54) SYSTEM MONITOR

(71) Applicant: Intel Corporation, Santa Clara, CA (US)

(72) Inventors: CHRIS PAVLAS, Hillsboro, OR (US); SCOTT DUBAL, Beaverton, OR (US); Sharada Shiddibhavi, Santa Clara, CA (US); Amritha Nambiar, Santa Clara, CA (US); TREVOR COOPER, Portland, OR (US); Robert Love, Santa Clara, CA (US); Calin Gherghe, Santa Clara, CA (US)

(73) Assignee: Intel Corporation, Santa Clara, CA (US)

(21) Appl. No.: 16/793,050

(22) Filed: Feb. 18, 2020

Related U.S. Application Data
(63) Continuation of application No. 15/282,113, filed on Sep. 30, 2016.

(51) Int. Cl. H04L 29/06; G06F 21/55; G06F 11/30

(52) U.S. Cl. CPC H04L 63/1416; G06F 2221/034; G06F 11/3006; G06F 21/552

(57) ABSTRACT

One embodiment provides an apparatus. The apparatus includes detector circuitry and monitor logic local to a computing device. The detector circuitry is to generate local sensor data based, at least in part, on a sensor signal received from a sensor incorporated in the local computing device. The monitor logic is to identify an event based, at least in part, on the local sensor data. The generating and identifying is independent of operation of an operating system and/or an application executing on the local computing device.

This application is a continuation of U.S. application Ser. No. 15/282,113, filed Sep. 30, 2016, the teachings of which are incorporated by reference in their entirety.

### FIELD

The present disclosure relates to a monitor, in particular to, a system monitor.

### BACKGROUND

Predicting or detecting faults and/or security events in a computer system may rely on software methods. Even with roots-of-trust, certificates and other sophisticated schemes, attacks may be possible in a software-based system. For example, software-based systems may be interfered with and/or reprogrammed without the interference and/or reprogramming necessarily being detected. Further, detection may be compromised by the fault itself since the fault may impact correct execution of a software detection algorithm.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a functional block diagram of a system that includes monitor circuitry, a plurality of sensors and a computing device consistent with several embodiments of the present disclosure;

FIG. 2 illustrates a functional block diagram of a networked monitor system consistent with several embodiments of the present disclosure; and

FIG. 3 is a flowchart of monitor circuitry operations according to various embodiments of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure relates to a system monitor. An apparatus, method and/or system includes monitor circuitry and one or more sensors incorporated in a computing device. The sensors may be coupled to and/or integrated with each of a plurality of monitored elements (e.g., processor, memory, motherboard, external storage, etc.) of the computing device. The monitor circuitry is configured to generate respective sensor data based, at least in part, on a respective sensor signal received from each sensor. Sensor data may include, but is not limited to, a voltage, a current, a temperature, a voltage variation, a current variation, a temperature variation, a frequency and/or a frequency variation, etc.

The sensors may include, but are not limited to, a voltage sensor, a current sensor and/or a temperature sensor. Each sensor may be physically positioned on, in or near a respective monitored element and may be coupled to the monitor circuitry. For example, a voltage sensor may include electrical conductors, e.g., contacts, traces, that are coupled to the monitored element. In another example, a current sensor may include a sense resistor. In another example a temperature sensor may include a thermistor, a thermocouple, a temperature sensing integrated circuit, etc. A subset of the sensors may be spatially distributed across a monitored element and/or across the computing device. Thus, a “map” of sensor data may be generated for the monitored element and/or the computing device.

The monitor circuitry is further configured to identify an event based, at least in part, on the sensor data. The event may be identified based, at least in part, on a comparison between local sensor data and stored sensor data retrieved from a monitor data store. An event may include, but is not limited to, an actual security event, a precursor security event, an actual fault event and/or a precursor fault event. An actual event is an event that is occurring or has occurred. A precursor event is an event that may occur. A precursor event may thus have an associated likelihood of occurrence in a time interval. Security events may include, for example, an external network-based attack on a computing device, an internal virus, a Trojan, etc. Fault events may correspond to, for example, failure of a monitored element failure, e.g., failure of one or more elements of processor, failure of a chipset, communication interface failure, an overvoltage condition, an overcurrent condition, an overtemperature condition, etc.

The monitor circuitry may be further configured to select a response based, at least in part, on the identified event. The response may include one or more of notify an end-user of the event, notify an administrator system of the event, isolate an element of the computing device, initiate migration of a workload, store the sensor data to a monitor data store and/or continue monitoring. Generating the sensor data, identifying the event and selecting the response are configured to be independent of operation of an operating system (OS) and/or an application that may be executing on the computing device. In other words, operations of the monitor system (i.e., monitor circuitry and associated sensors) are not controlled by the OS.

In an embodiment, a plurality of monitor systems, each incorporated in a respective computing device, may be included in a networked monitor system. Each monitor system may include a respective monitor circuitry and associated sensors. For example, the plurality of computing devices may be included in a data center. In this embodiment, the plurality of monitor circuitries may be coupled via a monitor network. One or more of the monitor circuitries may be configured to transmit or receive remote sensor data to/from other of the plurality of monitor circuitries. Each monitor circuitry may then be configured to identify the event further based, at least in part, on received remote sensor data.

In an embodiment, an administrator system may be configured to generate a decision rule related to each event based, at least in part, on selected sensor data received from at least some of one or more of a plurality of monitor circuitries. Each monitor circuitry may be configured to receive the decision rule from the administrator system. Each monitor circuitry then may be configured to identify the event further based, at least in part, on the decision rule. The decision rule may be generated utilizing one or more of a Bayesian network, a linear regression, a neural network, a machine learning technique and/or statistical analysis. The decision rule may be generated based, at least in part, on sensor data and based, at least in part on the event associated with the sensor data, as described herein. The decision rule may be generated based, at least in part, on, for example, a history of sensor data values that correspond to previously provided sensor data.

Thus, operations of the monitor system may not be susceptible to effects of corruption of the OS and/or an application nor to successful malware attacks on the OS and/or application(s) executing on the computing device. The apparatus, method and/or system are configured to identify security and/or fault events based, at least in part, on sensor data. Identification of an event may be relatively fast, in part because the monitor circuitry, including monitor logic, is local to (i.e., is coupled to and/or integrated with) the computing device and, in part, because the monitor circuitry is implemented in circuitry.

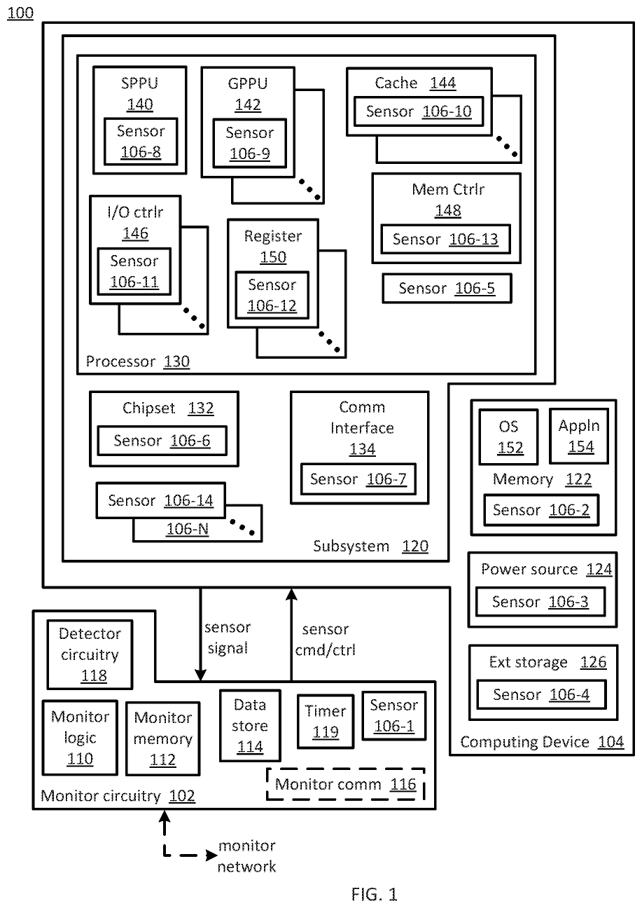

FIG. 1 illustrates a functional block diagram of a system 100 consistent with several embodiments of the present disclosure. System 100 includes monitor circuitry 102, a plurality of sensors 106-1, . . . , 106-N and computing device 104. Monitor circuitry 102 is coupled to and/or may be included in computing device 104. Sensor 106-1 may be incorporated in monitor circuitry 102. Sensors 106-2, . . . , 106-N are incorporated in computing device 104. As used herein, “incorporated in” means coupled to and/or integrated with. For example, “integrated with” may correspond to being manufactured, e.g., fabricated, with a corresponding monitored element.

Computing device 104 may include, but is not limited to, a mobile telephone including, but not limited to a smart phone (e.g., iPhone®, Android®-based phone, Blackberry®, Symbian®-based phone, Palm®-based phone, etc.); a wearable device (e.g., wearable computer, “smart” watches, smart glasses, smart clothing, etc.) and/or system; an Internet of Things (IoT) networked device including, but not limited to, a sensor system (e.g., environmental, position, motion, etc.) and/or a sensor network (wired and/or wireless); a computing system (e.g., a server, a workstation computer, a desktop computer, a laptop computer, a tablet computer (e.g., iPad®, GalaxyTab® and the like), an ultraportable computer, an ultramobile computer, a netbook computer and/or a subnotebook computer; etc.

Computing device 104 may include a subsystem 120, e.g., a motherboard, memory 122, a power source 124 and external storage 126. Memory 122 is configured to store, and thus may include, an operating system (OS) 152 and one or more application(s), e.g., application 154. Computing device 104 may further include a processor 130, a chipset 132 and a communication interface 134. For example, processor 130 may include one or more processing units, e.g., a special purpose processing unit 140 and one or more general purpose processing units, e.g., general purpose processing unit 142, one or more cache memories, e.g., cache 144, one or more I/O controllers, e.g., I/O controller 146, a memory controller 148 and one or more processor registers, e.g., processor register 150. Special purpose processor 140 may include, but is not limited to, a graphics processing unit, a math coprocessor, etc. Each general purpose processing unit 142 may correspond to a processing core that may include one or more hardware threads. Each processor register, e.g., processor register 150, may be coupled to or included in a respective processing unit, e.g., general purpose processing unit 142.

Each element 120, 122, 124, 126, 130 (including elements 140, 142, 144, 146, 148, 150), 132 and/or 134 of computing device 104 may generate heat and/or may generate and/or consume power during operation. A status, i.e., “health”, of each element may be indicated by one or more of temperature, voltage, current and/or variation thereof associated with each element, i.e., associated with each monitored element. Corresponding sensor data associated with each monitored element may then be utilized to identify an event, as described herein.

Each element of computing device 104 may include one or more sensors incorporated in, i.e., coupled to and/or integrated with, the respective element. Memory 122 may include sensor 106-2. Power source 124 may include sensor 106-3. External storage 126 may include sensor 106-4. Processor 130 may include sensor 106-5. Chipset 132 may include sensor 106-6. Communication interface 104 may include sensor 106-7. Special purpose processing unit 140 may include sensor 106-8. General-purpose processing unit 142 may include sensor 106-9. Cache memory 144 may include sensor 106-10. I/O controller 146 may include sensor 106-11. Register 150 may include sensor 106-12. Memory controller 148 may include sensor 106-13. Subsystem (e.g., motherboard) 120 may include one or more sensors, e.g., sensors 106-14, . . . , 106-N. For example, sensors 106-14, . . . , 106-N may be distributed over subsystem 120, e.g., positioned at various spatial locations.

The sensors 106-1, . . . , 106-N may include, but are not limited to, voltage sensors, current sensors and/or temperature sensors, etc. Each sensor 106-1, . . . , 106-N may be physically positioned on, in or near a respective monitored element 120, 122, 124, 126, 130 (including elements 140, 142, 144, 146, 148, 150), 132 and/or 134 and may be coupled to the monitor circuitry 102. For example, a voltage sensor may include electrical conductors, e.g., contacts and/or traces, that are coupled to, and/or integrated with, the monitored element. In another example, a current sensor may include a sense resistor coupled to and/or integrated with the monitored element. In another example a temperature sensor may include a thermistor, a thermocouple, a temperature sensing integrated circuit, etc., positioned in, on or near the monitored element. A subset of the sensors 106-1, . . . , and/or 106-N may be spatially distributed across a monitored element and/or across the computing device 104. Thus, a “map” of sensor data may be generated for the monitored element and/or the computing device. The map may include sensor data associated with each sensor location.

Each sensor 106-1, . . . , 106-N may have a corresponding sensor identifier configured to allow monitor circuitry 102 to identify the sensor and thus, a physical, i.e., spatial, location relative to a corresponding monitored element and/or the monitored element. The sensor identifier may be provided to monitor circuitry 102 with the sensor signal and/or in response to a request (e.g., in response to a sensor command and/or control signal) from monitor circuitry 102.

Monitor circuitry 102 may be configured to receive a respective sensor signal from each sensor 106-1, . . . , 106-N. For example, the sensor signal may include a voltage and/or a current. Monitor circuitry 102 may then be configured to generate corresponding sensor data based, at least in part, on the received sensor signal. Sensor data may include, but is not limited to, voltage, current, temperature, voltage variation, current variation, temperature variation, a frequency of a sensor signal, phase of a sensor signal, variation in frequency, variation in phase, etc. As used herein, “sensor data” may include an analog value and/or a digital representation of the analog value.

Thus, one or more of sensors 106-1, . . . , and/or 106-N may be incorporated in the computing device 104 and may be coupled to and/or integrated with each of the plurality of monitored elements.

Monitor circuitry 102 includes monitor logic 110, monitor memory 112, monitor data store 114, detector circuitry 118 and a timer 119. Monitor circuitry 102 may further include monitor communication interface 116 and/or the sensor 106-1. For example, monitor circuitry 102 may correspond to an application-specific integrated circuit (ASIC), a field-programmable gate array (FPGA), a microcontroller, a system-on-a-chip (SoC) or the like.

Detector circuitry 118 is configured to receive a sensor signal and to generate corresponding sensor data based, at least in part, on the sensor signal. For example, detector circuitry 118 may contain one or more of an analog to digital converter (ADC), an amplifier, a comparator (e.g., level and/or window), a multiplexer (MUX), a peak detector, a phase detector, a frequency detector, etc.

Detector circuitry 118 is configured to receive sensor signals, e.g., voltages and/or currents, from each sensor 106-1, . . . , 106-N. Detector circuitry 118 may be further configured to process the received sensor signal, e.g., amplify, convert an analog signal to a digital representation, etc. The corresponding sensor data may then be stored to monitor data store 114. The sensor data may be associated with a sensor identifier in, for example, a lookup table in monitor data store 114. Each sensor identifier may be associated with a monitored element identifier and/or a spatial position in computing device 104. The sensor data may be associated with a timestamp provided by, e.g., timer 119.

Thus, sensors 106-1, . . . , 106-N may be configured to detect a physical parameter, e.g., current, voltage, temperature, etc., and to output a sensor signal, e.g., a voltage and/or a current. The voltage and/or current may then be provided to and received by detector circuitry 118 configured to generate corresponding sensor data. The sensor data may then be stored to monitor data store 114 associated with a corresponding sensor identifier. The sensor identifier may be associated with a spatial position in computing device 104 (e.g., subsystem 120 and/or processor 130) and/or a monitored element identifier. Sensor data store 114 may be further configured to store a timestamp associated with each sensor data value. For example, the timestamp may be retrieved from timer 119. Sensor data, sensor identifiers, position and/or monitored element identifiers and/or timestamps may then be utilized by monitor logic 110 to identify an event, as described herein.

Monitor logic 110 may be configured to identify an event based, at least in part, on sensor data. The event may be identified based, at least in part, on a comparison between local sensor data and stored sensor data retrieved from a monitor data store. For example, test (i.e., local) sensor data may be compared to stored (e.g., legitimate, “known good”) sensor data, stored to monitor data store 114. Test sensor data may be generated based, at least in part, on a test sensor signal received from a corresponding sensor during operation of computing device 104. An event may then be identified based, at least in part, on a comparison of the test sensor data and the stored sensor data.

An event may include, but is not limited to an actual security event, a precursor security event, an actual fault event and/or a precursor fault event. An actual event is an event that is occurring or has occurred. A precursor event is an event that may occur. A precursor event may thus have a corresponding likelihood of occurrence in a time interval. Security events may include, for example, an external network-based attack on computing device 104, an internal virus, a Trojan, etc. Actual fault events may correspond to, for example, a monitored element failure, e.g., failure of one or more elements of processor 130, chipset 132 failure, communication interface 134 failure, an overvoltage condition, an overcurrent condition, an overtemperature condition, etc. Precursor fault events may include an indicator that a monitored element is likely to fail in a time interval.

For example, sensor 106-2 included in memory 122 may correspond to a plurality of voltage sensors. Sensor data may then correspond to a distribution of voltages across at least a portion of the memory 122. Sensor signals corresponding to the voltages may be received and corresponding sensor data generated during access to, e.g., a selected memory region included in the at least a portion of memory 122. Legitimate sensor data may be generated during known legitimate access to a selected memory region. For example, the legitimate sensor data may be generated during access by a legitimate application that yields a corresponding voltage distribution, i.e., signature. In another example, the legitimate sensor data may be generated during access by another legitimate application that is configured to provide a selected voltage distribution, i.e., a selected signature. The legitimate sensor data (i.e., signature) may then be stored to monitor data store 114. Monitor circuitry 102 may then be configured to receive test sensor signals (e.g., voltages) from sensor 106-2 and to generate corresponding test (i.e., local) sensor data, during operation of computing device 104. For example, monitor circuitry 102 may be configured to generate the test data when the selected memory region contains sensitive data. Monitor logic 110 may then be configured to compare the local sensor data to the stored sensor data that corresponds to a signature. If the access to the selected memory region is not legitimate, the test sensor data may generate a different pattern of voltages, i.e., a different signature. The monitor logic 110 may then identify an actual security event based, at least in part, on a comparison of the legitimate stored sensor data and the local test sensor data. Temperature distributions and sensor data that corresponds to temperature may similarly be utilized to generate “signatures” and to identify an event.

In another example, variation in voltage and/or current greater than a threshold may indicate that a monitored element is tending toward failure. In other words, the variation in voltage and/or current greater than the threshold may correspond to a precursor fault event. Based on sensor identifiers, for example, the voltage and/or current variations may be mapped to a physical, i.e., spatial, location in computing device 104 and, e.g., subsystem 120. The spatial location and/or monitored element may be determined based on the sensor identifiers, for example, and, thus, the voltage and/or current variation (e.g., voltage or current gradient) may be associated with one or more elements of processor 130 (e.g., special purpose processing unit 140, general purpose processing unit 142, cache 144, I/O controller 136, processor registers 150 and/or memory controller 148). Based on timestamp data, for example, the variation in voltage and/or current over time may be determined by, e.g., monitor logic 110. The variation in voltage and/or current may be related to time and/or frequency.

In another example, a temperature value greater than a threshold may indicate that a monitored element is tending towards failure. Thus, variation in temperature greater than a threshold may correspond to a precursor fault event. Similar to voltage and/or current, based on sensor identifiers, temperature values may be mapped spatially over, e.g., computing device 104, subsystem 120 and/or processor 130. A temperature gradient greater than a threshold between a plurality of locations may correspond to a precursor fault event. Temperature variation over time may also be determined based, at least in part, on generated temperature data and based, at least in part, on timestamp data from, e.g., timer 119.

Thus, sensor data may be mapped spatially, i.e., according to position and/or location in or on computing device 104, and/or temporally, e.g., in the time domain and/or frequency domain. The mapping may be determined by, e.g., monitor logic 110, based, at least in part, on sensor data, sensor identifiers and/or time information provided by, e.g., timer 119, and stored to monitor data store 114. The mapping information may similarly be stored to monitor data store 114.

The information stored to monitor data store 114 may be utilized by, e.g., monitor logic 110, to identify an event and to then select a corresponding response. For example, a voltage jitter, i.e., a voltage variation over a selected time interval, associated with a processor register, e.g., register 150, may be associated with an increased bit error rate (BER) for the processor register 150. In another example, a temperature gradient between spatial locations in computing device 104 above a threshold may correspond to a precursor fault event, i.e., may indicate that a monitored element is likely to fail in a finite time interval. In another example, a variation in a communication signal, e.g., associated with, interface 134 may be associated with a communication interface 134 precursor fault event.

Monitor logic 110 may be configured to identify an event based, at least in part, on the sensor data. The event may be identified based, at least in part, on a comparison between local sensor data and stored sensor data retrieved from a monitor data store. Monitor logic 110 may then be further configured to select a response based, at least in part, on the identified event. For example, monitor data store 114 may be configured to store a nominal value and/or range of nominal values for sensor data, i.e., associated with each sensor 106-1, . . . , 106-N. Sensor data outside of the nominal range and/or greater than a threshold difference between a nominal value and a generated sensor data value may correspond to an event. The event may be identified based, at least in part, on a comparison between current (i.e., local) sensor data and previously generated (i.e., stored) sensor data. For example, the previously generated sensor data may be associated, for example, with a known previous event. In another example, the previously generated sensor data may be associated with normal operating conditions.

In an embodiment, monitor logic 110 may be configured to identify an event based, at least in part, on a plurality of types of sensor data. Types of sensor data may include, but are not limited to, temperature, voltage, current, frequency as well as variations thereof. For example, monitor logic 110 may be configured to identify an event based, at least in part, on a combination of temperature and voltage and/or temperature variation and voltage variation. The temperature, voltage, and/or variations thereof may be analyzed for a single monitored element, for a subsystem, e.g., subsystem 120, over a spatial region and/or over a time interval.

Monitor logic 110 may be configured to select a response based, at least in part, on the identified event. Responses may include but are not limited to notifying an end-user, notifying an administrator system, isolating a monitored element, storing local sensor data to the monitor data store 114, initiating migration of a workload and/or to continue monitoring. The response selected may be based, at least in part, on whether the event is an actual event or a precursor event. The response selected may be based, at least in part, on a policy. For example, monitor logic 110 may be configured to utilize data analytics to select a response. Data analytics is a technique that may be utilized to select an output based, at least in part, on an input. The input may be relatively simple, e.g., one identified event, or the input may be relatively complex, e.g., a history of identified events over a time period.

In another example, a response selected based, at least in part, on an event associated with a memory region, e.g., a region of memory 122, may include quarantining the memory region. The selected response may further include executing diagnostics on the quarantined memory region. For example, hardened, e.g., secure, circuitry may be configured to provide the quarantine and/or run the diagnostic tests. In a relatively extreme example, the hardened circuitry may be configured to overwrite (i.e., “brick”) some or all of the memory to thus prevent access to memory contents.

In another example, in a system, e.g., system 200, as described herein, that includes a plurality of computing devices, e.g., computing device 104, the response selected may include migrating a workload from a first computing device to a second computing device. In another example, for an event associated with an I/O device, e.g., I/O controller 146, an associated area of the I/O device may be isolated. For example, the hardened, e.g., secure, circuitry may be configured to isolate the associated area of the I/O device. In another example, the selected response may include storing generated sensor data that may then be utilized to improve future identification of an event.

A response selected based, at least in part, on an event with relatively minor effects may be different from the response selected based, at least in part, on an event with relatively more significant effects. For example, a fault event that corresponds to a failure of a computing device or an element of the computing device may result in a selected response that includes migrating a workload and/or notifying the administrator system. In another example, a security event, e.g., an internal virus, may result in selecting a response that includes notifying the end-user.

Thus, the decision rule is configured to relate sensor data and an event. The selected response may be related to characteristics of the event, e.g., the severity of the effect of the event if the event occurs, likelihood an actual event associated with a precursor event will occur. In a relatively simple case, a decision rule may be configured to relate a voltage or a temperature greater than a corresponding threshold to a precursor fault event or an actual fault event. In a relatively more complicated case, a decision rule may be configured to relate a variation in sensor data values, e.g., voltages and/or temperatures, spatially and/or temporally to an event. Spatially distributed sensor data values may correspond to, e.g., a topographical map that associates a sensor data value with the position in, e.g., computing device 104. Temporally distributed sensor data values may correspond to one physical location and/or monitored element. Thus, an amount of sensor data that is input to a decision rule and a corresponding complexity of the decision rule may vary.

Thus, monitor logic 110 may be configured to identify an event based, at least in part, on the sensor data. The event may be identified further based, at least in part, on a decision rule. The decision rule is configured to relate sensor data to an event. For example, a decision rule output may be an event descriptor corresponding to an event when sensor data that correlates with the event is input to the decision rule. The event descriptor may include an event identifier, a precursor event or actual event indicator, a security event or fault event indicator and a likelihood indicator for precursor events. The likelihood indicator is configured to provide a likelihood that a corresponding actual event will occur in a time interval. One or more decision rules may be determined by, e.g., an administrator system, as described herein. Monitor logic 110 may thus be configured to utilize one or more decision rules provided by an administrator system and stored to monitor sensor data store 114 when identifying an event based, at least in part, on sensor data.

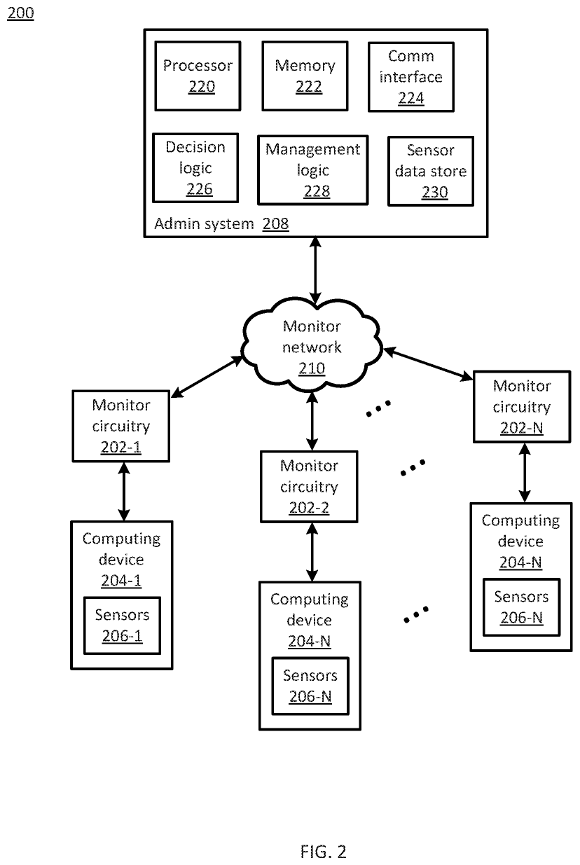

FIG. 2 illustrates a functional block diagram of a networked monitor system 200 consistent with several embodiments of the present disclosure. Networked monitor system 200 includes a plurality of monitor circuitries 202-1, 202-2, . . . , 202-N, the plurality of computing devices 204-1, 204-2, . . . , 204-N and a monitor network 210. For example, the plurality of computing devices 204-1, 204-2, . . . , 204-N may be included in a data center. Monitor network 210 is configured to couple the plurality of monitor circuitries 202-1, 202-2, . . . , 202-N. Each computing device 204-1, 204-2, . . . , 204-N includes a respective plurality of sensors 206-1, 206-2, . . . , 206-N. Each monitor circuitry 202-1, 202-2, . . . , 202-N corresponds to monitor circuitry 102 of FIG. 1. Each computing device 204-1, 204-2, . . . , 204-N corresponds to computing device 104 of FIG. 1. Each respective plurality of sensors 206-1, 206-2, . . . , 206-N corresponds to one or more of sensors 106-1, . . . , and/or 106-N of FIG. 1.

In an embodiment, one or more of the monitor circuitries 202-1, 202-2, . . . , and/or 202-N may be configured to share sensor data. In another embodiment, one or more of the monitor circuitries 202-1, 202-2, . . . , and/or 202-N may be configured to share event descriptors. One or more of the monitor circuitries 202-1, 202-2, . . . , and/or 202-N may be configured to identify a respective event based, at least in part, on local sensor data and based, at least in part, on remote sensor data received from one or more other monitor circuitries. Sharing sensor data is configured to facilitate “learning” by each monitor circuitry based, at least in part, on remote sensor data. In other words, trends associated with events may be identified relatively more quickly based, at least in part, on sensor data generated and shared by a plurality of monitor circuitries.

In some embodiments, networked monitor system 200 may include an administrator system 208. In these embodiments, the administrator system 208 may be coupled to one or more of the plurality of monitor circuitries 202-1, 202-2, . . . , 202-N by monitor network 210. Administrator system 208 includes a processor 220, memory 222 and a communication interface 224. Administrator system 208 may further include decision logic 226, management logic 228 and a sensor data store 230. Administrator system 208 is configured to generate a decision rule related to an event based, at least in part, on selected sensor data received from at least some of the one or more of the plurality of monitor circuitries 202-1, 202-2, . . . , 202-N.

In these embodiments, management logic 228 may be configured to receive sensor data from one or more of the monitor circuitries 202-1, 202-2, . . . , 202-N. Management logic 228 may be further configured to store the received sensor data to sensor data store 230. One or more of the monitor circuitries may be further configured to provide a respective event descriptor associated with the provided sensor data. For example, the event descriptor may correspond to an event that occurred prior to, at or within a time interval of a time associated sensor data was generated.

Decision logic 226 may be configured to process the received sensor data and associated event descriptor to generate a decision rule relating sensor data to the event that corresponds to the event descriptor. For example, decision logic 226 may be configured to implement one or more analysis techniques in order to identify a relationship between sensor data and an event. For example, the techniques may include, but are not limited to Bayesian network, a linear regression, a neural network, a machine learning technique and/or a statistical analysis. It may be appreciated that decision logic 226 may be relatively more powerful than monitor logic 110 of FIG. 1. The analysis techniques may further identify selected sensor data types that correlated relatively more strongly than other sensor data types with an event.

Management logic 228 may then be configured to provide the identified decision rule to one or more of monitor circuitries 202-1, 202-2, . . . , 202-N. The decision rule is configured to facilitate identification of an event by each of the monitor circuitries based, at least in part, on sensor data and further based, at least in part, on the decision rule. In other words, each decision rule may be configured to relate selected sensor data generated based, at least in part, on sensor signals received from at least some of the plurality of sensors to an event.

Each monitor circuitry may be configured to utilize the decision rule to identify an event based, at least in part, on sensor data. Utilizing a decision rule may be relatively faster than determining the decision rule. Thus, identifying an event based, at least in part, on sensor data may be performed by monitor circuitry that may be relatively less powerful then, e.g., administrator system 208.

Thus, monitor circuitry incorporated in a computing device may be configured to generate sensor data based, at least in part, on a sensor signal received from a sensor incorporated in the computing device. Monitor circuitry may be further configured to identify an event (e.g., security and/or fault, actual or precursor) based, at least in part, on sensor data. A response may then be selected based, at least in part, on the identified event. The generating, identifying and selecting may be independent of an OS and/or an application that may be executing on the computing device.

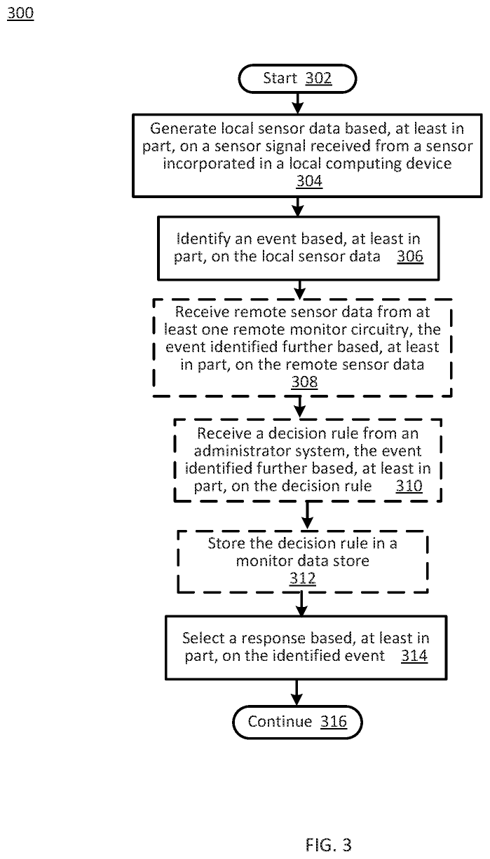

FIG. 3 is a flowchart 300 of monitor circuitry operations according to various embodiments of the present disclosure. In particular, the flowchart 300 illustrates generating sensor data and identifying an event based, at least in part, on the sensor data. The operations may be performed, for example, by monitor circuitry 102, e.g., detector circuitry 118, monitor logic 110 and/or monitor communication interface 116 of FIG. 1 and/or monitor circuitries 202-1, 202-2, . . . , 202-N of FIG. 2.

Operations of this embodiment may begin with start 302. Local sensor data may be generated based, at least in part, on a sensor signal received from a sensor incorporated in a local computing device at operation 304. An event may be identified based, at least in part, on the local sensor data at operation 306. In some embodiments, remote sensor data may be received from at least one remote monitor circuitry at operation 308. In these embodiments, the event identified may be further based, at least in part, on the remote sensor data. In other embodiments, remote sensor data may not be received. In another embodiment, a decision rule may be received from an administrator system in operation 310. In this embodiment, the event identified may be further based, at least in part, on the decision rule. In other embodiments, the decision rule may not be received. The decision rule may then be stored in a monitor data store at operation 312. A response may be selected based, at least in part, on the identified event at operation 314. Program flow may then continue in operation 316.

Thus, sensor data may be generated based, at least in part, on a sensor signal received from a sensor incorporated in a computing device. An event may be identified based, at least in part, on the sensor data and a response may be selected based, at least in part, on the identified event.

While the flowchart of FIG. 3 illustrates operations according to various embodiments, it is to be understood that not all of the operations depicted in FIG. 3 are necessary for other embodiments. In addition, it is fully contemplated herein that in other embodiments of the present disclosure, the operations depicted in FIG. 3 and/or other operations described herein may be combined in a manner not specifically shown in any of the drawings, and such embodiments may include less or more operations than are illustrated in FIG. 3. Thus, claims directed to features and/or operations that are not exactly shown in one drawing are deemed within the scope and content of the present disclosure.

Thus, an apparatus, method and/or system may include monitor circuitry and one or more sensors incorporated in a computing device. The sensors may be coupled to and/or integrated with each of a plurality of monitored elements (e.g., processor, memory, motherboard, external storage, etc.) of the computing device. The monitor circuitry is configured to generate respective sensor data based, at least in part, on a respective sensor signal received from each sensor. Sensor data may include, but is not limited to, a voltage, a current, a temperature, a voltage variation, a current variation, a temperature variation, a frequency and/or a frequency variation. The monitor circuitry is further configured to identify an event based, at least in part, on the sensor data. The monitor circuitry may be further configured to select a response based, at least in part, on the identified event. The generating and identifying are independent of operations of an OS and/or an application that may be executing on the computing device.

Thus, operations of the monitor system may not be susceptible to effects of corruption of the OS and/or an application nor to successful malware attacks on the OS and/or application(s) executing on the computing device. The apparatus, method and/or system are configured to identify security and/or fault events based, at least in part, on sensor data. Identification of an event may be relatively fast, in part because the monitor circuitry, including monitor logic, is local to the computing device and, in part, because the monitor circuitry is implemented in circuitry.

As used in any embodiment herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. For example, circuitry may include an application-specific integrated circuit (ASIC), a field-programmable gate array (FPGA), a microcontroller, a system-on-a-chip (SoC) or the like

The foregoing provides example system architectures and methodologies, however, modifications to the present disclosure are possible. The processor may include one or more processor cores and may be configured to execute system software. System software may include, for example, an operating system and/or an application. Device memory may include I/O memory buffers configured to store one or more data packets that are to be transmitted by, or received by, a network interface.

The operating system (OS) may be configured to manage system resources and control tasks that are run on, e.g., client device 104 and/or administrator system 208. For example, the OS may be implemented using Microsoft® Windows®, HP-UX®, Linux®, or UNIX®, although other operating systems may be used. In another example, the OS may be implemented using Android™, iOS, Windows Phone® or BlackBerry®. In some embodiments, the OS may be replaced by a virtual machine monitor (or hypervisor) which may provide a layer of abstraction for underlying hardware to various operating systems (virtual machines) running on one or more processing units. The operating system and/or virtual machine may implement one or more protocol stacks. A protocol stack may execute one or more programs to process packets. An example of a protocol stack is a TCP/IP (Transport Control Protocol/Internet Protocol) protocol stack comprising one or more programs for handling (e.g., processing or generating) packets to transmit and/or receive over a network.

Memory 112, 122 may each include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein, e.g., of administrator system 208, may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

In some embodiments, a hardware description language (HDL) may be used to specify circuit and/or logic implementation(s) for the various logic and/or circuitry described herein. For example, in one embodiment the hardware description language may comply or be compatible with a very high speed integrated circuits (VHSIC) hardware description language (VHDL) that may enable semiconductor fabrication of one or more circuits and/or logic described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

In some embodiments, a Verilog hardware description language (HDL) may be used to specify circuit and/or logic implementation(s) for the various logic and/or circuitry described herein. For example, in one embodiment, the HDL may comply or be compatible with IEEE standard 62530-2011: SystemVerilog—Unified Hardware Design, Specification, and Verification Language, dated Jul. 7, 2011; IEEE Std 1800™-2012: IEEE Standard for SystemVerilog-Unified Hardware Design, Specification, and Verification Language, released Feb. 21, 2013; IEEE standard 1364-2005: IEEE Standard for Verilog Hardware Description Language, dated Apr. 18, 2006 and/or other versions of Verilog HDL and/or SystemVerilog standards.

### EXAMPLES

Examples of the present disclosure include subject material such as a method, means for performing acts of the method, a device, or of an apparatus or system related to a system monitor, as discussed below.

### Example 1

According to this example, there is provided an apparatus. The apparatus includes detector circuitry and monitor logic local to a computing device. The detector is circuitry to generate local sensor data based, at least in part, on a sensor signal received from a sensor incorporated in the local computing device. The monitor logic is to identify an event based, at least in part, on the local sensor data. The generating and identifying are independent of operation of an operating system and/or an application executing on the local computing device.

### Example 2

This example includes the elements of example 1, wherein the local sensor data includes a voltage, a current, a temperature, a voltage variation, a current variation, a temperature variation, a frequency or a frequency variation.

### Example 3

This example includes the elements of example 1, wherein the event is selected from the group including an actual security event, a precursor security event, an actual fault event and a precursor fault event.

### Example 4

This example includes the elements of example 1, wherein the detector circuitry is to generate local sensor data based, at least in part, on a plurality of sensor signals received from a plurality of sensors incorporated in the local computing device.

### Example 5

This example includes the elements according to any one of examples 1 to 4, wherein the event is identified based, at least in part, on at least one of a distribution of local sensor data values across the local computing device, a distribution of local sensor data values over a time interval and/or a history of local sensor data values.

### Example 6

This example includes the elements according to any one of examples 1 to 4, further including a monitor communication interface to receive remote sensor data from at least one remote monitor circuitry, each remote monitor circuitry to generate the remote sensor data based, at least in part, on a remote sensor signal received from a remote sensor incorporated in a respective remote computing device, the event identified further based, at least in part, on the remote sensor data.

### Example 7

This example includes the elements according to any one of examples 1 to 4, wherein the monitor logic is further to select a response based, at least in part, on the identified event.

### Example 8

This example includes the elements of example 7, wherein the response is selected from the group including notify an end-user, notify an administrator system, isolate an element of the computing device, store the local sensor data to a monitor data store, initiate migration of a workload and/or continue monitoring.

### Example 9

This example includes the elements according to any one of examples 1 to 4, wherein the event is identified based, at least in part, on a comparison between the local sensor data and stored sensor data retrieved from a monitor data store.

### Example 10

This example includes the elements according to any one of examples 1 to 4, further including a monitor data store; and a monitor communication interface to couple the monitor logic to an administrator system, the response selected based, at least in part, on a decision rule received from the administrator system and stored to the monitor data store.

### Example 11

According to this example, there is provided a system. The system includes a plurality of sensors incorporated in a local computing device; detector circuitry and monitor logic local to the computing device. The detector circuitry is to generate local sensor data based, at least in part, on a sensor signal received from at least one sensor. The monitor logic is to identify an event based, at least in part, on the local sensor data. The generating and identifying are independent of operation of an operating system and/or an application executing on the local computing device.

### Example 12

This example includes the elements of example 11, wherein the local sensor data includes a voltage, a current, a temperature, a voltage variation, a current variation, a temperature variation, a frequency or a frequency variation.

### Example 13

This example includes the elements of example 11, wherein the event is selected from the group including an actual security event, a precursor security event, an actual fault event and a precursor fault event.

### Example 14

This example includes the elements of example 11, wherein the detector circuitry is to generate local sensor data based, at least in part, on a plurality of sensor signals received from a plurality of sensors incorporated in the local computing device.

### Example 15

This example includes the elements according to any one of examples 11 to 14, wherein the event is identified based, at least in part, on at least one of a distribution of local sensor data values across the local computing device, a distribution of local sensor data values over a time interval and/or a history of local sensor data values.

### Example 16

This example includes the elements according to any one of examples 11 to 14, further including a monitor communication interface to receive remote sensor data from at least one remote monitor circuitry, each remote monitor circuitry to generate the remote sensor data based, at least in part, on a remote sensor signal received from a remote sensor incorporated in a respective remote computing device, the event identified further based, at least in part, on the remote sensor data.

### Example 17

This example includes the elements according to any one of examples 11 to 14, wherein the monitor logic is further to select a response based, at least in part, on the identified event.

### Example 18

This example includes the elements of example 17, wherein the response is selected from the group including notify an end-user, notify an administrator system, isolate an element of the computing device, store the local sensor data to a monitor data store, initiate migration of a workload and/or continue monitoring.

### Example 19

This example includes the elements according to any one of examples 11 to 14, wherein the event is identified based, at least in part, on a comparison between the local sensor data and stored sensor data retrieved from a monitor data store.

### Example 20

This example includes the elements according to any one of examples 11 to 14, further including a monitor data store; and a monitor communication interface to couple the monitor logic to an administrator system, the response selected based, at least in part, on a decision rule received from the administrator system and stored to the monitor data store.

### Example 21

According to this example, there is provided a method. The method includes generating by, detector circuitry, local sensor data based, at least in part, on a sensor signal received from a sensor incorporated in a local computing device; and identifying by, monitor logic local to the computing device, an event based, at least in part, on the local sensor data. The generating and identifying are independent of operation of an operating system and/or an application executing on the local computing device.

### Example 22

This example includes the elements of example 21, wherein the local sensor data includes a voltage, a current, a temperature, a voltage variation, a current variation, a temperature variation, a frequency or a frequency variation.

### Example 23

This example includes the elements of example 21, wherein the event is selected from the group including an actual security event, a precursor security event, an actual fault event and a precursor fault event.

### Example 24

This example includes the elements of example 21, further including generating by, the detector circuitry, local sensor data based, at least in part, on a plurality of sensor signals received from a plurality of sensors incorporated in the local computing device.

### Example 25

This example includes the elements of example 21, wherein the event is identified based, at least in part, on at least one of a distribution of local sensor data values across the local computing device, a distribution of local sensor data values over a time interval and/or a history of local sensor data values.

### Example 26

This example includes the elements of example 21, further including receiving by, a monitor communication interface, remote sensor data from at least one remote monitor circuitry, each remote monitor circuitry to generate the remote sensor data based, at least in part, on a remote sensor signal received from a remote sensor incorporated in a respective remote computing device, the event identified further based, at least in part, on the remote sensor data.

### Example 27

This example includes the elements of example 21, further including selecting, by the monitor logic, a response based, at least in part, on the identified event.

### Example 28

This example includes the elements of example 27, wherein the response is selected from the group including notify an end-user, notify an administrator system, isolate an element of the computing device, store the local sensor data to a monitor data store, initiate migration of a workload and/or continue monitoring.

### Example 29

This example includes the elements of example 21, wherein the event is identified based, at least in part, on a comparison between the local sensor data and stored sensor data retrieved from a monitor data store.

### Example 30

This example includes the elements of example 21, further including coupling, by a monitor communication interface, the monitor logic to an administrator system, the response selected based, at least in part, on a decision rule received from the administrator system and stored to a monitor data store.

### Example 31

This example includes the elements of example 21, further including generating, by an administrator system, a decision rule related to the event based, at least in part, on selected sensor data received from at least some of one or more of a plurality of monitor circuitries, the administrator system coupled to the one or more of the plurality of monitor circuitries via a monitor network.

### Example 32

This example includes the elements of example 31, wherein the decision rule is generated based, at least in part, on one or more of a Bayesian network, a linear regression, a neural network, a machine learning technique and/or a statistical analysis.

### Example 33

According to this example, there is provided a system. The system includes a plurality of monitor circuitries and a monitor network coupling one or more of the plurality of monitor circuitries. Each monitor circuitry includes detector circuitry and monitor logic local to the computing device. The detector circuitry is to generate local sensor data based, at least in part, on a sensor signal received from a sensor incorporated in a local computing device. The monitor logic is to identify an event based, at least in part, on the local sensor data. The generating and identifying are independent of operation of an operating system and/or an application executing on the local computing device.

### Example 34

This example includes the elements of example 33, wherein the local sensor data includes a voltage, a current, a temperature, a voltage variation, a current variation, a temperature variation, a frequency or a frequency variation.

### Example 35

This example includes the elements of example 33, wherein the event is selected from the group including an actual security event, a precursor security event, an actual fault event and a precursor fault event.

### Example 36

This example includes the elements of example 33, wherein the detector circuitry is to generate local sensor data based, at least in part, on a plurality of sensor signals received from a plurality of sensors incorporated in the local computing device.

### Example 37

This example includes the elements according to any one of examples 33 to 36, wherein the event is identified based, at least in part, on at least one of a distribution of local sensor data values across the local computing device, a distribution of local sensor data values over a time interval and/or a history of local sensor data values.

### Example 38

This example includes the elements according to any one of examples 33 to 36, wherein each monitor circuitry further includes a monitor communication interface to receive remote sensor data from at least one remote monitor circuitry, each remote monitor circuitry to generate the remote sensor data based, at least in part, on a remote sensor signal received from a remote sensor incorporated in a respective remote computing device, the event identified further based, at least in part, on the remote sensor data.

### Example 39

This example includes the elements according to any one of examples 33 to 36, wherein the monitor logic is further to select a response based, at least in part, on the identified event.

### Example 40

This example includes the elements of example 39, wherein the response is selected from the group including notify an end-user, notify an administrator system, isolate an element of the computing device, store the local sensor data to a monitor data store, initiate migration of a workload and/or continue monitoring.

### Example 41

This example includes the elements according to any one of examples 33 to 36, wherein the event is identified based, at least in part, on a comparison between the local sensor data and stored sensor data retrieved from a monitor data store.

### Example 42

This example includes the elements according to any one of examples 33 to 36, wherein each monitor circuitry further includes a monitor data store; and a monitor communication interface to couple the monitor logic to an administrator system, the response selected based, at least in part, on a decision rule received from the administrator system and stored to the monitor data store.

### Example 43

This example includes the elements according to any one of examples 33 to 36, further including an administrator system coupled to one or more of the plurality of monitor circuitries via the monitor network, the administrator system to generate a decision rule related to the event based, at least in part, on selected sensor data received from at least some of the one or more of the plurality of monitor circuitries.

### Example 44

This example includes the elements of example 43, wherein the decision rule is generated based, at least in part, on one or more of a Bayesian network, a linear regression, a neural network, a machine learning technique and/or a statistical analysis.

### Example 45

According to this example, there is provided a device. The device includes means for generating by, detector circuitry, local sensor data based, at least in part, on a sensor signal received from a sensor incorporated in a local computing device; and means for identifying by, monitor logic local to the computing device, an event based, at least in part, on the local sensor data. The generating and identifying are independent of operation of an operating system and/or an application executing on the local computing device.

### Example 46

This example includes the elements of example 45, wherein the local sensor data includes a voltage, a current, a temperature, a voltage variation, a current variation, a temperature variation, a frequency or a frequency variation.

### Example 47

This example includes the elements of example 45, wherein the event is selected from the group including an actual security event, a precursor security event, an actual fault event and a precursor fault event.

### Example 48

This example includes the elements of example 45, further including means for generating by, the detector circuitry, local sensor data based, at least in part, on a plurality of sensor signals received from a plurality of sensors incorporated in the local computing device.

### Example 49

This example includes the elements according to any one of examples 45 to 48, wherein the event is identified based, at least in part, on at least one of a distribution of local sensor data values across the local computing device, a distribution of local sensor data values over a time interval and/or a history of local sensor data values.

### Example 50

This example includes the elements according to any one of examples 45 to 48, further including means for receiving by, a monitor communication interface, remote sensor data from at least one remote monitor circuitry, each remote monitor circuitry to generate the remote sensor data based, at least in part, on a remote sensor signal received from a remote sensor incorporated in a respective remote computing device, the event identified further based, at least in part, on the remote sensor data.

### Example 51

This example includes the elements according to any one of examples 45 to 48, further including means for selecting, by the monitor logic, a response based, at least in part, on the identified event.

### Example 52

This example includes the elements of example 51, wherein the response is selected from the group including notify an end-user, notify an administrator system, isolate an element of the computing device, store the local sensor data to a monitor data store, initiate migration of a workload and/or continue monitoring.

### Example 53

This example includes the elements according to any one of examples 45 to 48, wherein the event is identified based, at least in part, on a comparison between the local sensor data and stored sensor data retrieved from a monitor data store.

### Example 54

This example includes the elements according to any one of examples 45 to 48, further including means for coupling, by a monitor communication interface, the monitor logic to an administrator system, the response selected based, at least in part, on a decision rule received from the administrator system and stored to a monitor data store.

### Example 55

This example includes the elements according to any one of examples 45 to 48, further including means for generating, by an administrator system, a decision rule related to the event based, at least in part, on selected sensor data received from at least some of one or more of a plurality of monitor circuitries, the administrator system coupled to the one or more of the plurality of monitor circuitries via a monitor network.

### Example 56

This example includes the elements according to any one of examples 45 to 48, wherein the decision rule is generated based, at least in part, on one or more of a Bayesian network, a linear regression, a neural network, a machine learning technique and/or a statistical analysis.

### Example 57

According to this example, there is provided a system. The system includes at least one device arranged to perform the method of any one of examples 21 to 32.

### Example 58

According to this example, there is provided a device. The device includes means to perform the method of any one of examples 21 to 32.

### Example 59

According to this example, there is provided a computer readable storage device.

The device has stored thereon instructions that when executed by one or more processors result in the following operations including: the method according to any one of examples 31 and 32.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. An administration system, comprising:
management circuitry to receive sensor data and event descriptor data from at least one remote computing device; wherein the sensor data includes at least one selected from the group of voltage data, current data, temperature data, voltage variation data, current variation data, temperature variation data, frequency data of the sensor signal data, phase data of the sensor signal, variation data in the frequency data, or variation data in the phase data;
decision circuitry to generate a decision rule based on the sensor data and the event descriptor data, wherein the decision rule to identify a relationship between the sensor data and the event descriptor; and
communications circuitry to transmit the decision rule to the at least one remote computing device to enable the at least one computing device to identify an event in the at least one computing device; wherein the event includes at least one selected from the group of event type identifier, a precursor event data, an actual event, a security event, a fault event data, or a likelihood indicator related to the precursor event.

2. The administration system of claim 1, wherein the decision circuitry to generate the decision rule using a technique, the technique includes at least one selected from the group of a Bayesian network technique, a linear regression technique, a neural network technique, a machine learning technique, or a statistical analysis technique.

3. The administration system of claim 1, wherein the decision circuitry further to identify selected sensor data that correlates to the event.

4. The administration system of claim 1, wherein the event is identified based, at least in part, on at least one of a distribution of sensor data values across the at least one computing device, a distribution of sensor data values of the at least one computing device over a time interval and/or a history of sensor data values of the at least one computing device.

5. The administration system of claim 1, further comprising a data storage device to store at least one of the sensor data or the event descriptor data.

6. The administration system of claim 1, wherein the event descriptor data corresponds to the event that occurred prior to, at or within a time interval of a time when the sensor data is generated.

7. A method comprising:
receiving, by management circuitry, sensor data and event descriptor data from at least one remote computing device; wherein the sensor data includes at least one selected from the group of voltage data, current data, temperature data, voltage variation data, current variation data, temperature variation data, frequency data of the sensor signal data, phase data of the sensor signal, variation data in the frequency data, or variation data in the phase data;
generating, by decision circuitry, a decision rule based on the sensor data and the event descriptor data, wherein the decision rule to identify a relationship between the sensor data and the event descriptor; and
transmitting, by communications circuitry, the decision rule to the at least one remote computing device to enable the at least one computing device to identify an event in the at least one computing device; wherein the event includes at least one selected from the group of event type identifier, a precursor event data, an actual event, a security event, a fault event data, or a likelihood indicator related to the precursor event.

8. The method of claim 7, further comprising generating, by the decision circuitry, the decision rule using a technique, the technique includes at least one selected from the group of a Bayesian network technique, a linear regression technique, a neural network technique, a machine learning technique, or a statistical analysis technique.

9. The method of claim 7, further comprising identifying, by the decision circuitry, selected sensor data that correlates to the event.

10. The method of claim 7, wherein the event is identified based, at least in part, on at least one of a distribution of sensor data values across the at least one computing device, a distribution of sensor data values of the at least one computing device over a time interval and/or a history of sensor data values of the at least one computing device.

11. The method of claim 7, further comprising storing, on a data storage device, at least one of the sensor data or the event descriptor data.

12. The method of claim 7, wherein the event descriptor data corresponds to the event that occurred prior to, at or within a time interval of a time when the sensor data is generated.

13. At least one computer-readable device having stored thereon instruction, that when executed by at least one processor, cause the at least one processor to perform operations comprising:
receive sensor data and event descriptor data from at least one remote computing device; wherein the sensor data includes at least one selected from the group of voltage data, current data, temperature data, voltage variation data, current variation data, temperature variation data, frequency data of the sensor signal data, phase data of the sensor signal, variation data in the frequency data, or variation data in the phase data;
generate a decision rule based on the sensor data and the event descriptor data, wherein the decision rule to identify a relationship between the sensor data and the event descriptor; and
transmit the decision rule to the at least one remote computing device to enable the at least one computing device to identify an event in the at least one computing device; wherein the event includes at least one selected from the group of event type identifier, a precursor event data, an actual event, a security event, a fault event data, or a likelihood indicator related to the precursor event.

14. The at least one computer-readable device of claim 13 having stored thereon instruction, that when executed by at least one processor, further cause the at least one processor to perform operations comprising generate the decision rule using a technique, the technique includes at least one selected from the group of a Bayesian network technique, a linear regression technique, a neural network technique, a machine learning technique, or a statistical analysis technique.

15. The at least one computer-readable device of claim 13 having stored thereon instruction, that when executed by at least one processor, further cause the at least one processor to perform operations comprising identify selected sensor data that correlates to the event.

16. The at least one computer-readable device of claim 13, wherein the event is identified based, at least in part, on at least one of a distribution of sensor data values across the at least one computing device, a distribution of sensor data values of the at least one computing device over a time interval and/or a history of sensor data values of the at least one computing device.

17. The at least one computer-readable device of claim 13 having stored thereon instruction, that when executed by at least one processor, further cause the at least one processor to perform operations comprising store at least one of the sensor data or the event descriptor data.

18. The at least one computer-readable device of claim 13, wherein the event descriptor data corresponds to the event that occurred prior to, at or within a time interval of a time when the sensor data is generated.
